(19) United States
(12) Patent Application Publication
(10) Pub. No.: US 2012/0246229 A1
(43) Pub. Date: Sep. 27, 2012

(54) Notifying Participants that a Conference is Starting

(75) Inventors: Timothy Carr, Effretikon (CH); Brian Douglas King, Zurich (CH); Elia Noris, Zurich (CH)

(73) Assignee: MICROSOFT CORPORATION, Redmond, WA (US)

(21) Appl. No.: 13/052,884

(22) Filed: Mar. 21, 2011

(51) Int. Cl. G06F 15/16

(52) U.S. Cl. 709/204

(57) ABSTRACT

A conferencing service enables users to schedule telecommunication conferences. At the time when the host of a previously scheduled conference joins the conference, one or more participants of the conference do not have active communication sessions with the conferencing service. In response to the host joining the conference, the conferencing service notifies such participants that the conference is starting. Because the conferencing service notifies these participants that the conference is starting, it may be unnecessary for these participants to wait on hold for the host to join the conference.

### BACKGROUND

When people collaborate on a project, frequently they need to hold meetings to exchange ideas and information. When it is inconvenient for all of the people to be together in the same place, the people can schedule a telephone conference, video conference, online meeting, or another type of telecommunication conference. Such conferences can involve more than two people and can be scheduled to begin at particular times. For example, a conference can involve six people and can be scheduled to begin at 10:00 a.m. on Apr. 25, 2011.

To participate in a conference using a telephone, a person can dial a phone number associated with a conferencing service. The person then dials a passcode associated with the conference. Upon validating the passcode, the conferencing service can start providing the audio data of the conference to the person's telephone and can start providing sounds made by the person to other people who have joined the conference.

Frequently, a person organizing the telecommunication conference acts as a host for the conference. The other people participating in the conference act as participants of the conference. The conference does not start until the conference's host joins the conference. If other participants of the conference try to join the conference before the conference's host joins the conference, the conferencing service puts the conference's participants on hold until the conference's host joins the conference. When the conferencing service puts a participant on hold, the conferencing service may play music to the participant.

For various reasons, the conference's host might not join the conference at the time that the conference is scheduled to start. For example, the host may be stuck in another meeting or may have forgotten that the meeting was scheduled to occur. Consequently, the conference's participants may be forced to wait for prolonged periods while waiting for the host to join the conference. Waiting on hold for prolonged periods can be annoying to the participants and may result in lost productivity.

### SUMMARY

A conferencing service enables users to schedule telecommunication conferences. At the time when the host of a previously scheduled conference joins the conference, one or more participants of the conference do not have active communication sessions with the conferencing service. For example, some participants may have attempted to join the conference at the conference's scheduled start time, but then terminated their communication sessions with the conferencing service when the host did not join the conference at the conference's scheduled start time. In response to the host joining the conference, the conferencing service notifies such participants that the conference is starting. Because the conferencing service notifies the participants that the conference is starting, it may be unnecessary for these participants to wait on hold for the host to join the conference.

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

### BRIEF DESCRIPTION OF THE DRAWINGS

FIG. 1 illustrates an example communication system.

FIG. 2 is a flowchart illustrating an example operation of a conferencing system.

FIG. 3 is a block diagram illustrating example components of the conferencing system.

FIG. 4 is a flowchart illustrating an example operation of a focus manager when scheduling a conference.

FIG. 5 is a block diagram illustrating example conference data for the conference.

FIG. 6 is a flowchart illustrating a further operation of the focus manager.

FIG. 7 is a flowchart illustrating an example operation of a conference thread for a conference.

FIG. 8 is a flowchart illustrating a portion of the example operation of the conference thread when the conference thread receives a participant join event.

FIG. 9 is a flowchart illustrating an example participant joining process.

FIG. 10 is a block diagram illustrating example physical details of an electronic computing device.

### DETAILED DESCRIPTION

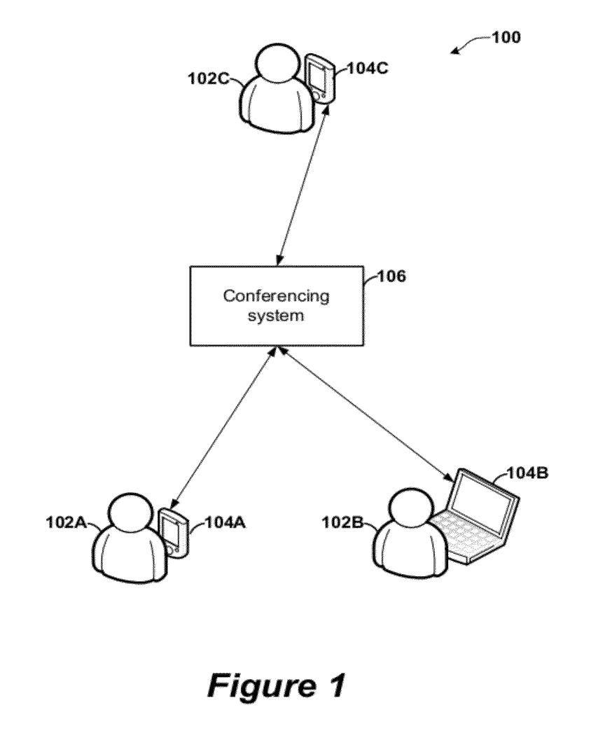

FIG. 1 illustrates an example communication system 100. The communication system 100 includes a set of users 102A-C (collectively, “users 102”). Although the example of FIG. 1 only illustrates three users 102, it should be appreciated that the communication system 100 can include more or fewer users. The users 102 are individual people. For example, the users 102 can be employees of one or more companies. Each of the users 102 has a communication device 104A-C, respectively. This document can refer to the communication devices 104A-C collectively as communication devices 104.

The communication devices 104 can comprise a wide variety of different types of computing devices. For example, one or more of the communication devices 104 can be mobile telephones, cordless telephones, landline telephones, tablet computers, handheld computers, laptop computers, desktop computers, video conferencing devices, audio conferencing devices, in-car communication devices, wearable computing devices, or other types of computing devices. The example of FIG. 1 shows one of the communication devices 104 as a laptop computer and two of the communication devices 104 as mobile phones. It should be appreciated that the communication devices 104 can comprise types of computing devices other than those illustrated in the example of FIG. 1.

The users 102 use the communication devices 104 to engage in various types of synchronous communication sessions with one another. For example, the users 102 can use the communication devices 104 to engage in telephone calls, video conferences, online meetings, instant message sessions, chat sessions, desktop sharing sessions, and/or other types of communication that occur in the context of a session to which computing resources are allocated.

In some instances, two or more of the users 102 may want to engage in a conference with each other at a predetermined time in the future. For example, two or more of the users 102 may want to hold a telephone conference with each other on April 1 at 10:00 a.m. In such instances, an organizer communicates with a conferencing system 106 to schedule a conference.

A conference has at least one modality. A modality is a type of communication. For example, a conference can have a voice modality in which the users 102 in the conference can vocally speak with one another. In another example, a conference can have an instant messaging modality in which the users 102 in the conference can exchange instant messages with each other. In some embodiments, a conference can concurrently have multiple modalities. For example, a conference can have a voice modality and also have a web meeting modality in which the users 102 in the conference can see electronic slides presented by one or more of the users 102 in the conference.

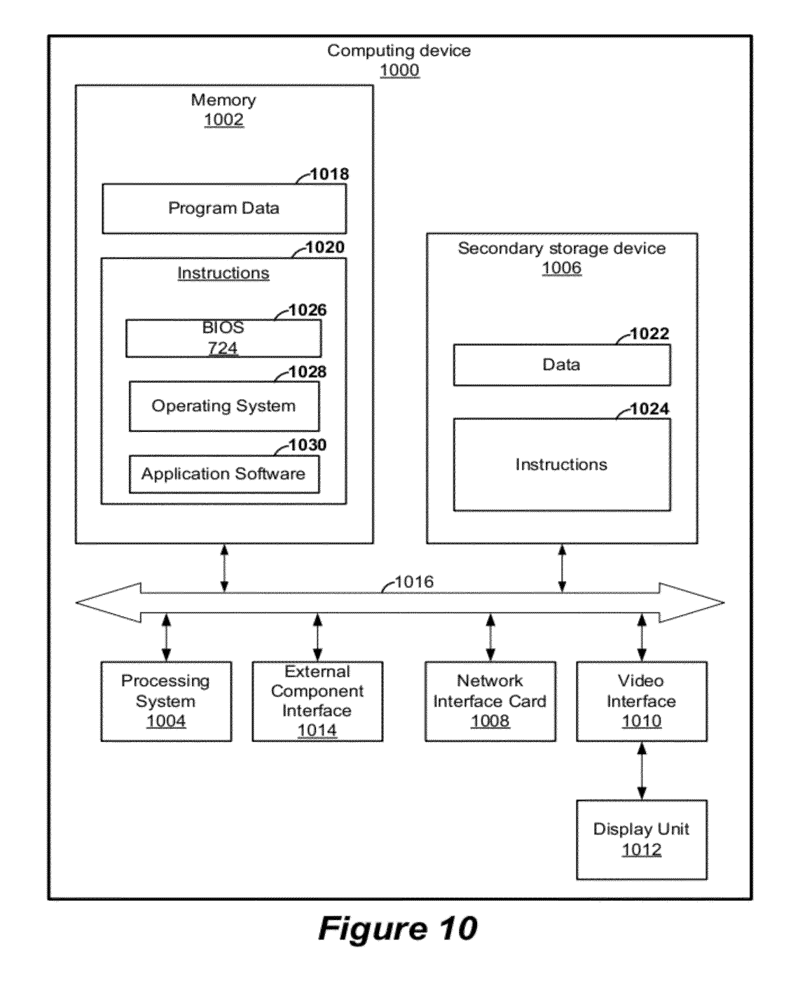

In addition to the users 102 and the communication devices 104, the communication system 100 includes a conferencing system 106 that facilitates such conferences. The conferencing system 106 comprises one or more computing devices. For example, the conferencing system 106 can comprise one or more server computers, blade server computers, personal computers, intermediate network devices, mainframe computers, and/or other types of computers. In some embodiments where the conferencing system 106 comprises more than one computing device, the computing devices in the conferencing system 106 can be geographically distributed or alternately concentrated within a single room, building, or data center. In some embodiments, the conferencing system 106 comprises one or more computing devices of the type illustrated in the example of FIG. 10.

To join a conference, the communication devices 104 establish communication sessions with the conferencing system 106. The communication devices 104 can establish communication sessions with the conferencing system 106 over various communication networks (not shown). For example, the communication devices 104 can establish communication sessions with the conferencing system 106 over a POTS network, a cellular telephone network, a local area network (LAN), a wide area network, the Internet, and/or another type of communication network. Such communication networks can include wired and/or wireless communication links.

When an organizer of the conference sets up the conference, the organizer designates at least one of the users 102 as a host of the conference. For example, the organizer can designate the user 102C as the host of the conference. In some instances, the organizer can designate multiple users 102 as hosts of the conference. This document refers to the users 102 who the organizer did not designate as hosts of the conference as “participants” of the conference. After a host of the conference joins the conference, the users 102 who have joined the conference can communicate with each other through the conference. However, a conference does not start until the host of the conference joins the conference. If a participant of the conference tries to join the conference before the host joins the conference, the conferencing system 106 may put the participant on hold until the host joins the conference.

If the host is late joining the conference, the participant may wait on hold for a considerable amount of time. This may be inconvenient to the participant and result in lost productivity. To reduce this inconvenience, the participant can provide a notification request to the conferencing system 106 before the host joins the conference. The notification request instructs the conferencing system 106 to notify the participant when the host has joined the conference. After the participant provides the notification request to the conferencing system 106, the communication session between the conferencing system 106 and the participant terminates.

Subsequently, the conferencing system 106 receives a request from the host to join the conference. At this time, the participant does not have an active communication session with the conferencing system 106. In response to the host joining the conference, the conferencing system 106 notifies the participant that the conference is starting. The conferencing system 106 notifies the participant that the conference is starting because the participant provided the notification request to the conferencing system 106 before the host joined the conference. Upon receiving the notification, the participant can start a new communication session with the conferencing system 106 and join the conference. In this way, providing the notification request to the conferencing 106 system can spare the participant from the inconvenience of spending time on hold until the host joins the conference.

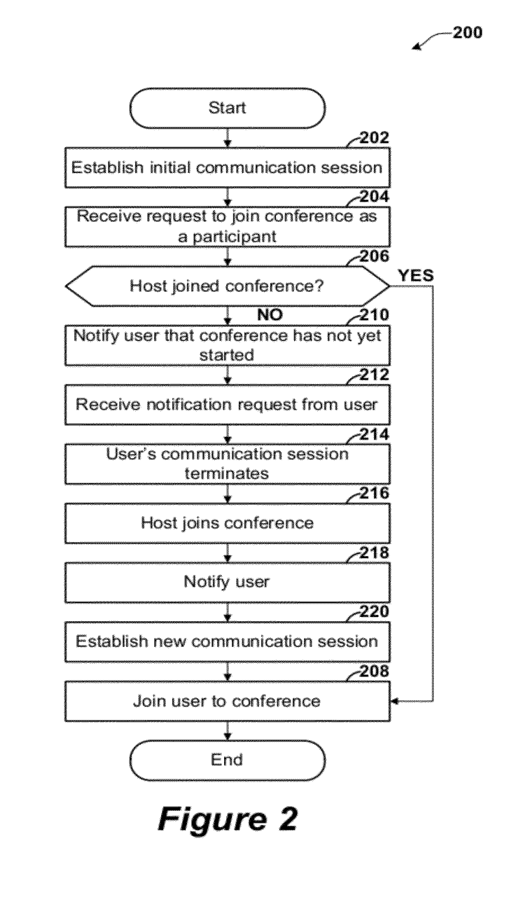

FIG. 2 is a flowchart illustrating an example operation 200 of the conferencing system 106. The example of FIG. 2 is described with regard to actions performed by the user 102A and the communication device 104A. It should be understood that the actions in FIG. 2 can be performed other ones of the users 102 and other ones of the communication devices 104.

The operation 200 begins when the conferencing system 106 establishes an initial communication session with the user 102A (202). For example, the conferencing system 106 can begin a telephone communication session when the user 102A dials a telephone number for the conferencing system 106. In some instances, the conferencing system 106 establishes the initial communication session at approximately the time that a particular conference is scheduled to occur.

During the initial communication session, the conferencing system 106 receives a participant join request from the communication device 104A of the user 102A (204). The participant join request indicates that the user 102A wants to join a particular conference as a participant. In various instances, the conferencing system 106 can receive the participant join request in various ways. For example, the conferencing system 106 can receive the participant join request when the user 102A inputs a participant passcode for the conference. In this example, the initial communication session can be a telephone call and the conferencing system 106 can receive the participant join request as a sequence of touch-tones representing the participant passcode for the conference. In another example, the communication device 104A can automatically send the participant join request without needing to receive explicit input from the user 102A. In yet another example, the conferencing system 106 can receive the participant join request as one or more messages formatted in the Session Initiation Protocol (SIP) or another communication protocol.

After receiving the participant join request, the conferencing system 106 determines whether a host of the conference has already joined the conference (206). If a host of the conference has already joined the conference (“YES” of 206), the conferencing system 106 joins the user 102A to the conference (208). When the conferencing system 106 joins the user 102A to the conference, the conferencing system 106 provides media data of the conference to the communication device 104A. For example, if the conference has a voice modality and the communication device 104A is configured to support the voice modality, the conferencing system 106 sends the conference's voice data to the communication device 104A. In another example, if the conference has a videoconferencing modality and the communication device 104A is configured to support the videoconferencing modality, the conferencing system 106 sends the conference's audio and video data to the communication device 104A.

On the other hand, if no host of the conference has joined the conference yet (“NO” of 206), the conferencing system 106 notifies the user 102A that the conference has not yet started (210). In various embodiments, the conferencing system 106 can notify the user 102A that the conference has not yet started in various ways. For example, if the conference has a voice modality and the user's communication session is configured to support the voice modality, the conferencing system 106 can send data representing a vocal message to the communication device 104A. The vocal message tells the user 102A that the conference has not yet started. In another example, if the conference has an instant messaging modality and the communication device 104A is configured to handle the instant messaging modality, the conferencing system 106 can send an instant message to the communication device 104A indicating that the host has not yet joined the conference.

After notifying the user 102A that the conference has not yet started, the conferencing system 106 can receive a notification request from the user 102A (212). The notification request instructs the conferencing system 106 to notify the user 102A when a host of the conference joins the conference. In various embodiments, the conferencing system 106 can receive the notification request in various ways. For example, if the communication device 104A is a telephone, the user's communication session is a telephone call. In this example, the conferencing system 106 can receive the notification request as a series of touch-tones during the telephone call. In another example, the conferencing system 106 can receive the notification request through a web services interface, such as a HTTP web server.

After receiving the notification request from the user 102A, the initial communication session between the conferencing system 106 and the communication device 104A terminates (214). In various embodiments, the conferencing system 106 terminates the initial communication session in various ways. For example, the conferencing system 106 can automatically terminate the initial communication session in response to receiving the notification request. In other embodiments, the conferencing system 106 terminates the initial communication session when the user 102A performs some additional action, such as hanging up the user's telephone or sending a separate session termination request to the conferencing system 106.

At some time after the initial communication session between the conferencing system 106 and the communication device 104A terminates, the conferencing system 106 receives a host join request (216). The host join request indicates that a host of the conference wants to join the conference. At the time that the conferencing system 106 receives the host join request, the conferencing system 106 does not have an active communication session with the communication device 104A. For example, there may not be an ongoing telephone call between the conferencing system 106 and the communication device 104A.

After the host joins the conference, the conferencing system 106 notifies the user 102A that the host has joined the conference (218). In other words, the conferencing system 106 notifies the user 102A that the conference is starting. The conferencing system 106 notifies the user 102A that the host has joined the conference because the conferencing system 106 received a notification request from the user 102A. If the conferencing system 106 has not received a notification request from the user 102B at the time when the host joins the conference, the conferencing system 106 would not notify the user 102B that the host has joined the conference even if the user 102B previously provided a participant join request to the conferencing system 106.

After the conferencing system 106 notifies the user 102A that the host has joined the conference, the conferencing system 106 establishes a new communication session with the user 102A (220). In some embodiments, the conferencing system 106 establishes the new communication session as part of notifying the user 102A. In other instances, the user 102A may perform one or more actions to establish the new communication session after the conferencing system 106 notifies the user 102A that the conference is starting. For example, the conferencing system 106 may establish the new communication session when the conferencing system 106 receives a phone call from the user 102A.

After establishing the new communication session with the user 102A, the conferencing system 106 joins the user 102A to the conference (208). In this way, the communication device 104A of the user 102A can receive media data of the conference. In some instances, the conferencing system 106 joins the user 102A to the conference in response to receiving a participant join request from the user 102A during the new communication session. In other instances, the conferencing system 106 automatically joins the user 102A to the conference after starting the new communication session.

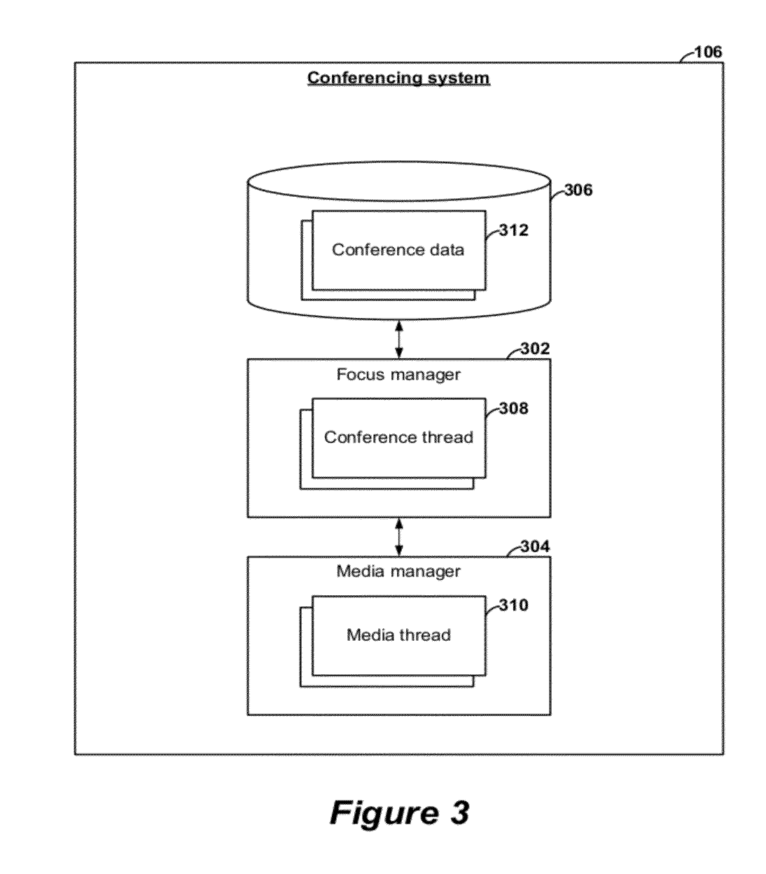

FIG. 3 is a block diagram illustrating example components of the conferencing system 106. The computing devices of the conferencing system 106 include or have access to one or more computer storage media that store computer-executable instructions. Execution of these computer-executable instructions by processing units in the computing devices in the conferencing system 106 configures the conferencing system 106 such that the conferencing system provides particular functionality. In the example of FIG. 3, execution of the computer-executable instructions by processing units in the conferencing system 106 causes the conferencing system 106 to provide a focus manager 302 and a media manager 304. Furthermore, the computer storage media store a database 306. In some instances, the focus manager 302 and the media manager 304 can be running on different computing devices in the conferencing system 106.

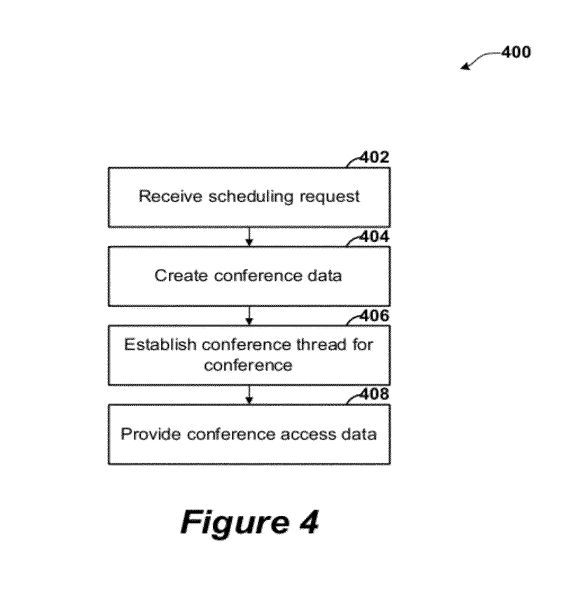

The focus manager 302 handles scheduling of conferences. When the focus manager 302 receives a request to schedule a conference, the focus manager 302 starts a conference thread to handle the new conference. Because there can concurrently be multiple scheduled conferences, multiple conference threads 308 can be running concurrently. FIG. 4, discussed in detail below, illustrates an example operation of the focus manager 302 when scheduling conferences.

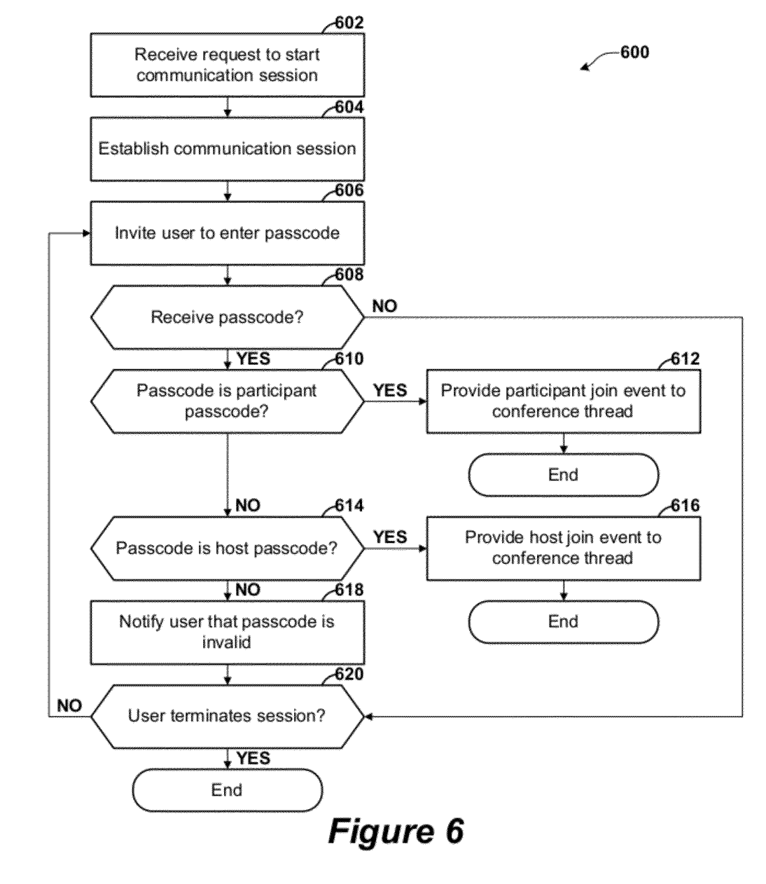

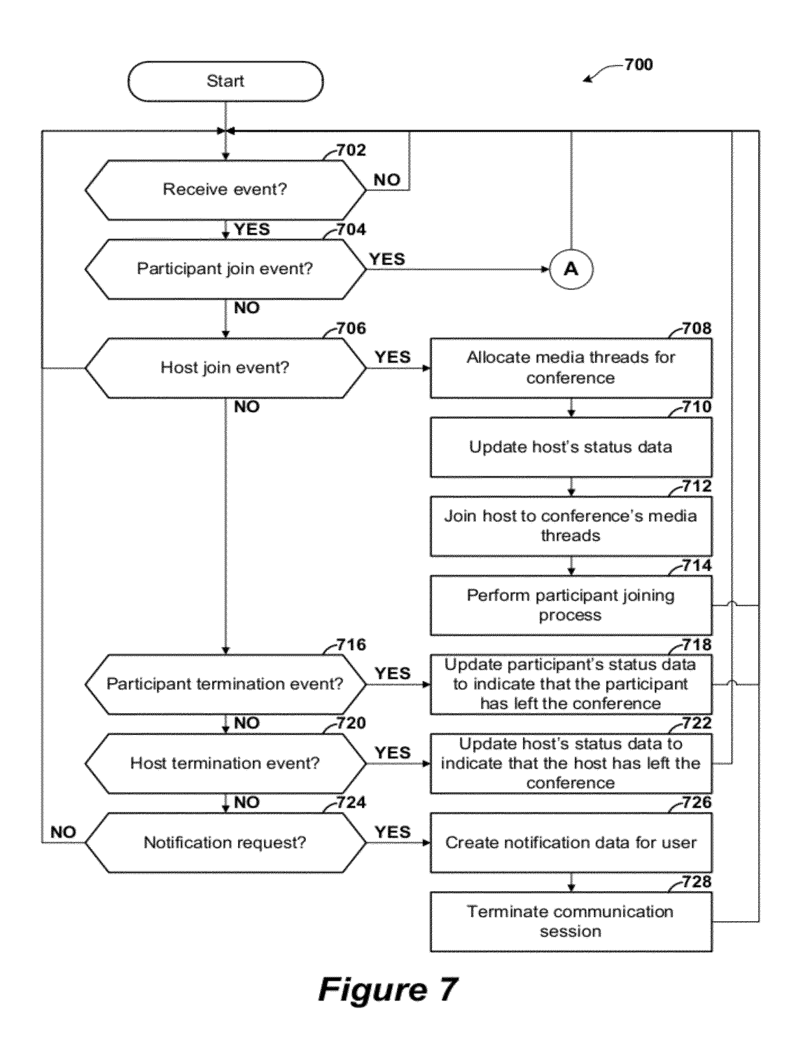

In addition, the focus manager 302 handles incoming requests to initiate communication sessions with the conferencing system 106. FIG. 6, discussed in detail below, shows an example operation of the focus manager 302 when handling an incoming request to initiate a communication session with the conferencing system 106. FIGS. 7-9, discussed in detail below, describe example operations performed by the conference threads 308.

The media manager 304 creates and manages media threads 310. The media threads 310 process media data for conferences. For example, one of the media threads 310 can receive voice data from the users 102 who have joined a conference, mix the sounds represented by the voice data, and send out the resulting voice data to the communication devices 104 of the users 102 who have joined the conference. In this example, another one of the media threads 310 can collect video data from the users 102 who have joined the conference, process this video data, and send the resulting video data out to the communication devices 104 of the users 102 who have joined the conference.

The database 306 stores a set of conference data 312 for each scheduled conference. The conference data 312 for a conference contains data regarding the conference. Various embodiments implement the database 306 in various ways. For example, various embodiments implement the database 306 as a relational database, a directory, an OLAP database, an associative database, an object-oriented database, an XML document, or another type of data structure that can store and provide reliable retrieval of the sets of conference data 312.

FIG. 4 is a flowchart illustrating an example operation 400 of the focus manager 302. As illustrated in the example of FIG. 4, the focus manager 302 receives scheduling input from a computing device used by an organizer (402). The organizer can be one of the users expected to join the conference, such as the conference's host, or another person. For example, the organizer can be the host's secretary.

The scheduling input comprises a request to schedule a conference. Furthermore, the scheduling input can include various types of information regarding the conference. For example, the scheduling input can indicate a time and date at which the conference is scheduled to occur, the conference's expected duration, a billing code for the conference, a number of users expected to join the conference, a list of the conference's hosts, a list of the conference's expected participants, a list of the conference's modalities, a recurrence schedule for the conference, and/or other types of information regarding the conference. In this example, the recurrence schedule for the conference indicates a periodic basis on which the conference recurs.

In various embodiments, the focus manager 302 can receive the scheduling input in various ways. For example, the conferencing system 106 can provide a web server that hosts a set of webpages. The webpages include data entry controls that enable the organizer to provide the scheduling input to the focus manager 302. In another example, the focus manager 302 can provide a voice interface that enables the organizer to provide the scheduling input to the focus manager 302. Some embodiments allow the organizer to provide different parts of the scheduling input to the focus manager 302 at different times. Furthermore, some embodiments allow the organizer to provide scheduling input that updates information specified by previous scheduling input.

After receiving the scheduling input, the focus manager 302 creates a set of conference data 312 in the database 306 for a new conference (404). In various embodiments, the set of conference data 312 can include various types of data regarding the telecommunication conference. For example, the focus manager 302 can create one or more entries in the database 306 to store the data indicated by the scheduling input.

Furthermore, after receiving the scheduling input, the focus manager 302 allocates a conference thread 308 to the conference (406). The conference thread 308 for the conference perform activities to set up the conference and to handle events regarding the conference. In various embodiments, the focus manager 302 allocates the conference thread 308 to the conference in various ways. For example, the focus manager 302 can allocate the conference thread 308 by instantiating a new thread. In another example, the focus manager 302 can allocate the conference thread 308 from a pool of unused conference threads previously created by the focus manager 302. FIGS. 7-9 discuss activities of the conference thread 308.

In addition, the focus manager 302 provides conference access data to one or more users (408). The conference access data informs participants and hosts of the conference how to join the conference. The conference access data can include a telephone number of the conferencing system 106, a host access code, a participant access code, time and data information for the conference, and/or other information regarding the conference. In various embodiments, the focus manager 302 can provide the conference access data to various users. For example, the conferencing system 106 can provide the conference access data to the organizer, a host of the conference, participants of the conference, or other users. Furthermore, in various embodiments, the focus manager 302 can provide the conference access data to the users in various ways. For example, the focus manager 302 can email the conference access data to the users. In another example, the focus manager 302 can provide the conference access data to the organizing user during a voice communication session or in a webpage when the organizing user provides the scheduling input.

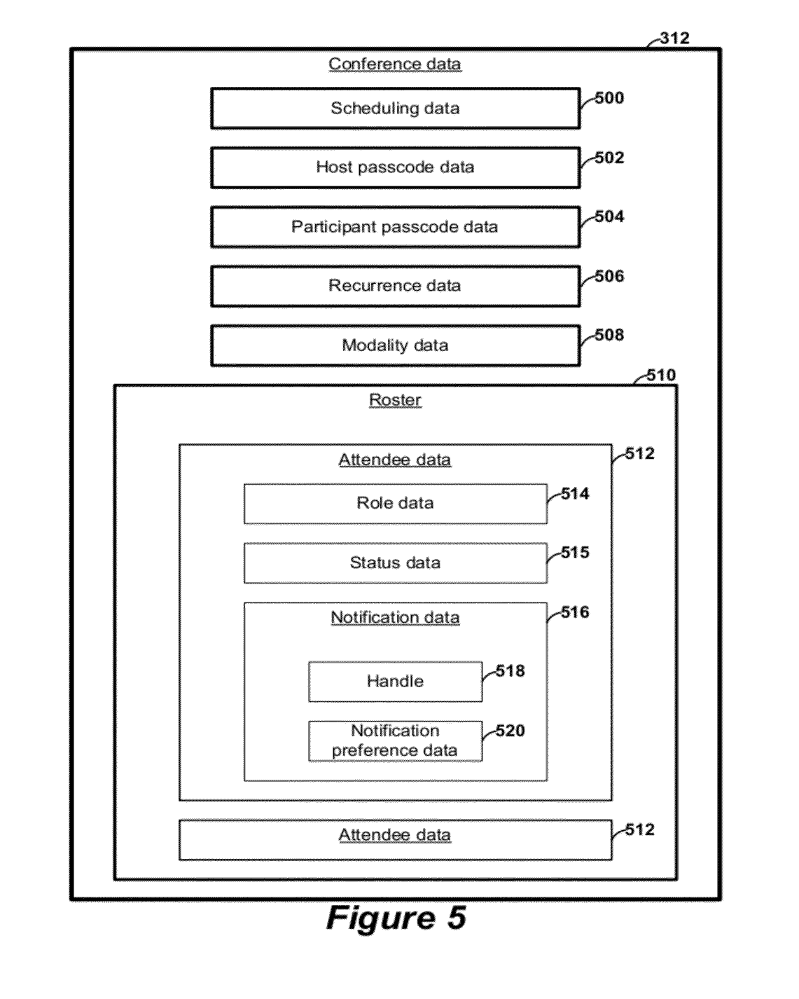

FIG. 5 is a block diagram illustrating example types of data included in the conference data 312 for a given conference. As illustrated in the example of FIG. 5, the conference data 312 includes scheduling data 500. The scheduling data 500 indicates a time and date at which the given conference is scheduled to occur. For instance, the scheduling data 500 can indicate a start time and a stop time for the given conference. Furthermore, the conference data 312 includes a host passcode 502 and a participant passcode 504. In some embodiments, the conferencing system 106 joins a given user to the given conference as a host of the given conference only if the given user provides the host passcode 502. Similarly, the conferencing system 106 only joins a given user to the given conference as a participant of the given conference if the given user provides the participant passcode 504. In some embodiments, the focus manager 302 generates the host passcode 502 and/or the participant passcode 504 automatically in response to receiving scheduling input regarding the given conference. In other embodiments, the focus manager 302 receives the host passcode 502 and/or the participant passcode 504 from the organizer with the scheduling input.

The conference data 312 also optionally includes recurrence data 506. Some conferences recur periodically at given intervals. For example, a conference can recur on the second Tuesday of every month at the same time. The recurrence data 506 indicates a periodic basis on which the conference recurs. For example, the recurrence data 506 can indicate that the given conference recurs every week at the 4:00 pm until the end of the year 2011.

When the given conference recurs, the conferencing system 106 can receive another host join request from the given conference's host at a time when a participant of the given conference does not have active communication sessions with the conferencing system 106. This other host join request indicates that the given conference's host wants to join the recurrence of the given conference. In this event, the conferencing system 106 notifies the participant that the recurrence of the given conference is starting if the participant provided a notification request to the conferencing system 106. In some instances, the participant's notification request can indicate that the conferencing system 106 is to notify the participant when each recurrence of the given conference is starting. In this way, the participant does not need to wait on hold for the host to join recurrences of the given conference. In other instances, the participant's notification request can indicate that the conferencing system 106 is to notify the participant when an individual recurrence is starting or when selected recurrences of the given conference are starting.

In addition, the conference data 312 can include modality data 508. The modality data 508 specifies modalities expected to be used in the given conference. For example, the modality data 508 can specify a voice modality and an online meeting modality.

Furthermore, the conference data 312 includes a roster 510. The roster 510 stores sets of attendee data 512. Each set of attendee data 512 contains data regarding a different attendee of the given conference. Attendees of a conference include the hosts and the participants of the conference. For example, the roster 510 can include a first, second, and third set of attendee data. In this example, the first set of attendee data contains data regarding a host of the given conference, the second set of attendee data contains data regarding a first participant of the given conference, and the third set of attendee data contains data regarding a second participant of the given conference.

As illustrated in the example of FIG. 5, a set of attendee data 512 for an attendee can include role data 514 for the attendee. The role data 514 for the attendee indicates whether the organizer has designated the attendee as a host of the given conference or a participant of the given conference. The attendee data 512 for an attendee also includes status data 515. The status data 515 indicates whether the attendee has joined the given conference or has left the given conference.

Furthermore, when the conferencing system 106 has received a notification request from an attendee, the attendee data 512 for the attendee can include notification data 516. The notification data 516 indicates that the attendee has requested to be notified when the given conference is starting.

In some instances, the notification data 516 for an attendee can include a handle 518. The handle 518 indicates a point-of-presence of the attendee on a communication system. For example, the handle 518 can indicate a phone number for the attendee that the conferencing system 106 is to call when the given conference is starting. In another example, the handle 518 can indicate an email address or instant messaging user name to which the conferencing system 106 is to send a message when the given conference is starting.

In addition to the handle 518, the notification data 516 for an attendee includes notification preference data 520. The notification preference data 520 indicates how the attendee wants to be notified that the given conference is starting. For example, the notification preference data 520 can indicate that the attendee wants to be notified by phone call or text message when the given conference is beginning.

Although not illustrated in the example of FIG. 5, the other sets of attendee data 512 can also include scheduling data, host passcode data, participant passcode data, recurrence data, modality data, and rosters. In other embodiments, the conference data 312 can include additional data. For example, the conference data 312 can include data specifying audio and/or video configurations for the given conference.

FIG. 6 is a flowchart illustrating a further operation 600 of the focus manager 302. The example of FIG. 6 is described with regard to actions performed by the user 102A and the communication device 104A. Readers will understand that that the actions in FIG. 6 can be performed other ones of the users 102 and other ones of the communication devices 104.

At some time after the focus manager 302 provides the conference access data to the users 102, the focus manager 302 receives a request from the communication device 104A associated with the user 102A to start a communication session (602). In various embodiments, the focus manager 302 can receive the request to start a communication session in various ways. For example, the focus manager 302 can receive a request to start a communication session as an incoming telephone call from the communication device 104A. In another example, the focus manager 302 can receive the request to start a communication session when the focus manager 302 receives a request from a soft phone or videoconferencing software operating on the communication device 104A. In this example, the request to start the communication session can conform to the SIP or another communication protocol.

After receiving the request to start the communication session from the communication device 104A, the focus manager 302 establishes the communication session between the conferencing system 106 and the communication device 104A (604). When the focus manager 302 establishes the communication session, the focus manager 302 can provide media data to the communication device 104A through the communication session. For example, the focus manager 302 can provide voice data representing a pre-recorded greeting to the communication device 104A.

Once the communication session has started, the focus manager 302 invites the user 102A to enter a passcode for a previously scheduled conference (606). Various embodiments of the focus manager 302 invite the user 102A to enter a passcode in various ways. For example, the focus manager 302 can send to the communication device 104A data representing a vocal message instructing the user 102A to input a passcode on a keypad of the communication device 104A. In another example, the focus manager 302 can send a message to the communication device 104A instructing the communication device 104A to display a message inviting the user 102A to enter a passcode.

The focus manager 302 then determines whether the focus manager 302 has received a passcode from the communication device 104A (608). In various embodiments, the focus manager 302 can receive a passcode from the communication device 104A in various ways. For example, when the communication device 104A is a telephone, the focus manager 302 can receive the passcode as a series of touchtone signals generated when the user 102A presses buttons on the telephone's keypad. In another example, when the communication device 104A has text input capabilities, the focus manager 302 can receive the passcode as text.

If the focus manager 302 has received a passcode from the communication device 104A (“YES” of 608), the focus manager 302 determines whether the received passcode is a participant passcode for a previously scheduled conference (610). In various embodiments, the focus manager 302 can determine whether the received passcode is a participant passcode for a previously scheduled conference in various ways. For example, to determine whether the received passcode is a participant passcode for a previously scheduled conference, the focus manager 302 can query the database 306 to determine whether the received passcode matches a participant passcode 504 stored in one of the sets of conference data 312.

If the focus manager 302 determines that the received passcode is a participant passcode for a previously scheduled conference (“YES” of 610), the focus manager 302 provides a participant join event to the conference thread 308 for the previously scheduled conference (612) and the operation 600 ends. On the other hand, if the focus manager 302 determines that the received passcode is not a participant passcode for a previously scheduled conference (“NO” of 610), the focus manager 302 determines whether the received passcode is a host passcode for a previously scheduled conference (614). In various embodiments, the focus manager 302 can determine whether the received passcode is a host passcode for a previously scheduled conference in a variety of ways. For example, the focus manager 302 can determine whether the received passcode is a host passcode for a previously-scheduled conference by querying the database 306 to determine whether the received passcode matches a host passcode 502 in one of the sets of conference data 312.

If the focus manager 302 determines that the received passcode is a host passcode for a previously scheduled conference (“YES” of 614), the focus manager 302 provides a host join event to the conference thread 308 for the previously scheduled conference (616). The operation 600 ends after the focus manager 302 provides the host join event to the conference thread 308.

If the focus manager 302 determines that the received passcode is not a host passcode for a previously scheduled conference (“NO” of 614), the focus manager 302 notifies the user 102A that the received passcode is invalid (618). In various embodiments, the focus manager 302 can notify the user 102A that the received passcode is invalid in various ways. For example, the focus manager 302 can notify the user 102A that the received passcode is invalid by sending to the communication device 104A voice data representing a spoken message. In this example, the spoken message informs the caller that the received passcode is invalid. In another example, the focus manager 302 can notify the user 102A that the received passcode is invalid by sending a message containing text data that informs the user 102A that the received passcode is invalid.

After notifying the user 102A that the received passcode is invalid or after determining that the conferencing system 106 did not receive a passcode (“NO” of 608), the focus manager 302 determines whether the communication session between the conferencing system 106 and the communication device 104A has terminated (620). In various embodiments, the focus manager 302 can determine whether the communication session has terminated in various ways. For example, if the communication device 104A is a telephone, the focus manager 302 can determine that the communication session has terminated when the conferencing system 106 has received a signal indicating that the user 102A has hung up the telephone. In another example, if the communication device 104A comprises a soft phone, the focus manager 302 can determine that the user's communication session has terminated when the conferencing system 106 has received a signal indicating that the communication device 104A has received input from the user 102A indicating that the user 102A wants to terminate the communication session. In yet another example, the focus manager 302 can determine that the communication session has terminated when the focus manager 302 has been unable to exchange data with the communication device 104A for a predetermined time. In this example, the focus manager 302 may be unable to exchange data with the communication device 104A for a variety of reasons, such as the communication device 104A abruptly powering off, the communication device 104A moving out of range of a wireless base station, or network connectivity problems.

In other embodiments, the focus manager 302 determines whether the number of times that the user 102A has entered invalid passcodes exceeds a predetermined threshold. If the number of times that the user 102A has entered invalid passcodes exceeds the threshold, the focus manager 302 places the user 102A in a virtual lobby. While the user 102A is in the virtual lobby, the user 102A can hear music. When a host of a conference's host joins the conference, the conferencing system 106 notifies the host that the user 102A is waiting in the virtual lobby. If the host wants the user 102A to join the conference, the host can instruct the conferencing system 106 to join the user 102A to the conference.

If the focus manager 302 determines that the communication session has terminated (“YES” of 620), the operation 600 ends. On the other hand, if the communication session has not yet terminated, the focus manager 302 can invite the user 102A to enter a passcode again (606). In some embodiments, the focus manager 302 can continue inviting the user 102A to enter a passcode until the user 102A enters a participant passcode or a host passcode for a previously scheduled conference or until the communication session terminates.

FIG. 7 is a flowchart illustrating an example operation 700 of the conference thread 308 for a conference.

When the conference thread 308 starts, the conference thread 308 determines whether the conference thread 308 has received an event (702). The conference thread 308 can receive events from various sources, such as the focus manager 302 and the media threads 310 allocated to the conference. If the conference thread 308 has not received an event (“NO” of 702), the conference thread 308 can wait until the conference thread 308 receives an event. While waiting to receive an event, the conference thread 308 can sleep or be dehydrated.

After the conference thread 308 has received an event (“YES” of 702), the conference thread 308 determines whether the received event is a participant join event (704). The participant join event indicates the conferencing system 106 has received a participant join request. As discussed above, users 102 can provide participant join requests to the conferencing system 106 by entering participant passcodes for conferences.

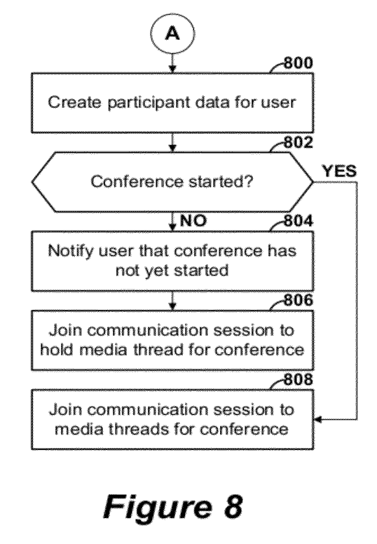

If the received event is a participant join event (“YES” of 704), the conference thread 308 performs the portion of the operation 700 illustrated in FIG. 8. After performing the portion of the operation 700 illustrated in FIG. 8, the conference thread 308 determines whether the conference thread 308 has received another event (702).

If the received event is not a participant join event (“NO” of 704), the conference thread 308 determines whether the received event is a host join event (706). The host join event indicates the conferencing system 106 has received a host join request. As discussed above, the users 102 can provide host join requests to the conferencing system 106 by entering host passcodes for conferences.

If the event is a host join event (“YES” of 706), the conference thread 308 allocates media threads 310 for the conference (708). In some embodiments, the conference thread 308 allocates at least one of the media threads 310 for each modality of the conference. The conference thread 308 can use the modality data 508 in the conference data 312 for the conference to identify the modalities of the conference. To allocate one of the media threads 310 for a particular modality, the conference thread 308 instructs the media manager 304 to allocate to the conference a new or existing media thread 310 capable of handling the particular modality.

After allocating the media threads 310 for the conference, the conference thread 308 updates the status data 515 for the host to indicate that the host has joined the conference (710). The conference thread 308 then joins the host to the media threads 310 for the conference (712). When the conference thread 308 joins the host to the media threads 310 for the conference, the media threads 310 receive media data from the host's communication device 104 and provide the conference's media to the host's communication device 104. For instance, one or more of the media threads 310 can use the host's communication session to send media data of the conference to the host's communication device 104 and to receive media data from the host's communication device 104.

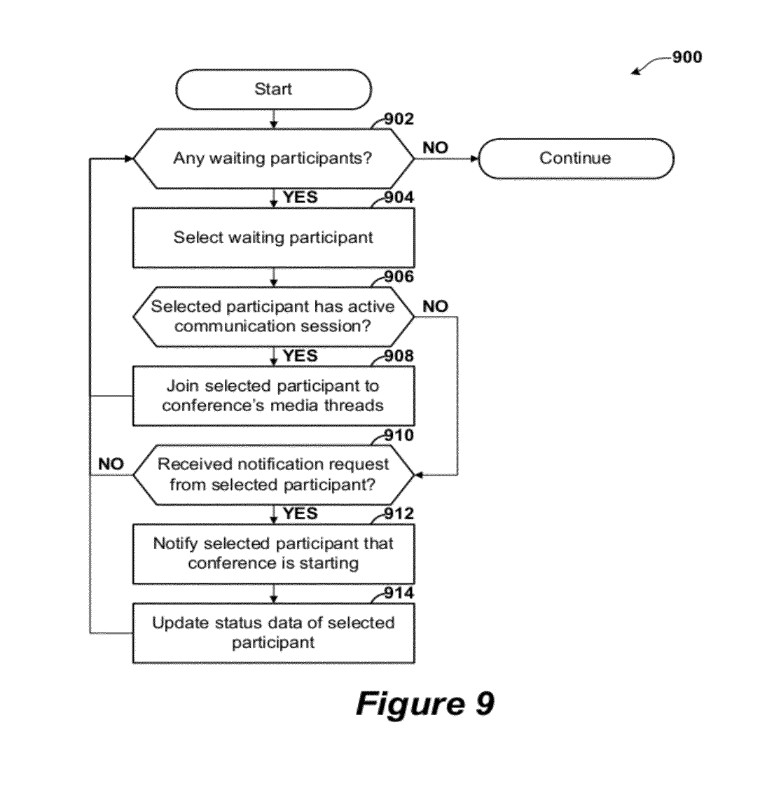

The conference thread 308 then performs a participant joining process (714). The participant joining process attempts to join participants to the conference. In various embodiments, the conference thread 308 can perform the participant joining process in various ways. FIG. 9, for example, illustrates one example participant joining process. Other participant joining processes are possible. After performing the participant joining process, the conference thread 308 waits to receive another event (702).

If the received event is not a host join event (“NO” of 706), the conference thread 308 determines whether the received event indicates that a participant's communication session has terminated (716). The conference thread 308 can receive an event indicating that the participant's communication session has terminated from one of the media threads 310 handling the participant's communication session. If a participant's communication session has terminated (“YES” of 716), the conference thread 308 updates the status data 515 for the participant to indicate that the participant has left the conference (718). The conference thread 308 then waits to receive another event (702).

If the received event does not indicate that a participant's communication session has terminated (“NO” of 716), the conference thread 308 determines whether the received event indicates that a host's communication session has terminated (720). The conference thread 308 can receive an event indicating that the host's communication session has terminated from one of the media threads 310 handling the host's communication session. If the host's communication session has terminated (“YES” of 720), the conference thread 308 updates the status data 515 for the host to indicate that the host has left the conference (722). In various embodiments, the conference thread 308 can perform various additional actions after the host leaves the conference. For example, the conference thread 308 can terminate the conference when one or all hosts of the conference leave the conference. In the example of FIG. 7, the conference thread 308 waits to receive another event after the host leaves the conference (702).

If the received event does not indicate that the host's communication session has terminated (“NO” of 720), the conference thread 308 determines whether the received event is a notification request (724). In various embodiments, the conference thread 308 can receive a notification request in various ways. For example, at least some of the media threads 310 are configured to detect notification requests from the users 102. In this example, such media threads provide notification requests to the conference thread 308 in response to detecting notification requests from the users 102. In another example, the conference thread 308 can receive a notification request from a web services interface or directly from the communication devices 104.

If the received event is a notification request (“YES” of 724), the conference thread 308 creates notification data 516 for a participant associated with the notification request (726). The notification data 516 indicates that the participant wants to be notified when the conference is starting. After the conference thread 308 creates the notification data, the conference thread 308 terminates the communication session (728).

In some embodiments, the notification request can specify notification preference data. The notification preference data indicates a manner in which the participant wants to be notified that the conference is starting. For example, the notification preference data can indicate that the participant wants to be notified by email, text message, phone call, instant message, or on-screen notification, or otherwise. In various embodiments, the participant can provide the notification preference data to the conferencing system 106 in various ways. For example, the conferencing system 106 can host a webpage that includes data entry controls that enable the participant to select a manner in which to be notified that the conference is starting. In another example, the conferencing system 106 provides an interactive voice response (IVR) system that enables the participant to specify how to be notified.

FIG. 8 is a flowchart illustrating a portion of the operation 700 performed when the conference thread 308 receives a participant join event. The conference thread 308 receives a participant join event when the conferencing system 106 receives a participant join request indicating that a given user wants to join a conference. Upon receiving the participant join event, the conference thread 308 updates the status data 515 for the given user to indicate that the given user has joined the conference (800).

After updating the status data 515 for the given user, the conference thread 308 determines whether the conference has already started (802). If the conference has already started, the host of the conference has already joined the conference. In various embodiments, the conference thread 308 determines whether the conference has already started in various ways. For example, the conference data 312 for the conference can indicate whether the conference has already started. In this example, the conference thread 308 can query the database 306 to learn whether the conference data 312 for the conference indicates that the conference has already started.

If the conference thread 308 determines that the conference has not started (“NO” of 802), the conference thread 308 notifies the given user that the conference has not yet started (804). The conference thread 308 can notify the given user that the conference has not yet started in various ways. For example, the conference thread 308 can send data to the given user's communication device 104 representing a spoken message. In this example, the spoken message indicates that the conference has not yet started. After notifying the given user that the conference has not yet started, the conference thread 308 joins the given user's communication session to a hold media thread for the conference (806). The hold media thread provides music data to the given user's communication device 104. The music data represents recorded music. In other embodiments, the hold media thread can send other types of audio or video data to the given user's communication device 104. The conference thread 308 then waits to receive another event (704).

On the other hand, if the conference thread 308 determines that the conference has started (“YES” of 802), the conference thread 308 joins the given user's communication session to the media threads 310 allocated to the conference (808). One or more of the media threads 310 can use the given user's communication session to send media data of the conference to the given user's communication device 104. The conference thread 308 then waits to receive another event (704).

FIG. 9 is a flowchart illustrating an example participant joining process 900. In some embodiments, multiple threads or processes perform the participant joining process 900 or a similar process in parallel. Performing the participant joining process 900 in parallel can decrease the amount of time required to perform the participant joining process 900.

As illustrated in the example of FIG. 9, the conference thread 308 performs the participant joining process 900 by first determining whether there are any remaining waiting participants of the conference (902). The waiting participants include participants of the conference who are waiting on hold for the conference to begin and unnotified participants. The unnotified participants are participants who provided notification requests to the conferencing system 106, but who have not yet been notified. In various embodiments, the conference thread 308 determines whether there are any waiting participants in various ways. For example, the conference thread 308 can use the attendee data 512 of the participants to identify waiting participants of the conference.

If there are one or more waiting participants (“YES” of 902), the conference thread 308 selects one of the waiting participants (904). In various embodiments, the conference thread 308 selects the participant from among the waiting participants in various ways. For example, the conference thread 308 can select participants from among the waiting participants according to an order in which the roster 510 lists the participants' attendee data 512. In another example, the conference thread 308 can select participants from among the participants on the roster 510 in an arbitrary manner.

After selecting one of the waiting participants, the conference thread 308 determines whether the selected participant has an active communication session (906). If the selected participant has an active communication session (“YES” of 906), the conference thread 308 joins the selected participant to the media threads 310 for the conference (908). If the selected participant has an active communication session, the selected participant may be waiting on hold for the conference to start. After the conference thread 308 joins the selected participant to the media threads 310 for the conference, the conference thread 308 determines again whether there are any remaining waiting participants (902) and the participant joining process 900 recurs.

On the other hand, if the selected participant does not have an active communication session (“NO” of 906), the conference thread 308 determines whether the conferencing system 106 has received a notification request from the selected participant (910). Various embodiments of the conference thread 308 determine whether the conferencing system 106 has received a notification request from the selected participant in various ways. For example, the conference thread 308 can determine that the conferencing system 106 has received a notification request from the selected participant by determining whether the attendee data 512 for the selected participant includes notification data 516. If the conferencing system 106 has not received a notification request from the selected participant (“NO” of 910), the conference thread 308 determines again whether there are any remaining waiting participants (902) and the participant joining process 900 recurs.

If the conferencing system 106 has received a notification request from the selected participant (“YES” of 910), the conference thread 308 notifies the selected participant that the conference is starting (912). In embodiments where the conferencing system 106 is configured to receive notification preference data 520 from participants, the conference thread 308 notifies the selected participant in the manner indicated by the notification preference data. For example, if the notification preference data 520 for the selected participant indicates that the selected participant wants to be notified with a text message, the conference thread 308 sends a text message to the selected participant. In this example, the text message can include a link or phone number for the selected participant to use to join the conference. In another example, if the notification preference data 520 for the selected participant indicates that the selected participant wants to be notified with a telephone call, the conference thread 308 makes a telephone call to the selected participant. In this example, the conference thread 308 can join the selected participant to the media threads 310 for the conference when the selected participant answers the telephone call. In yet another example, the conference thread 308 can send an email to the selected participant when the notification preference data 520 for the selected participant indicates that the selected participant wants to be notified by email.

After notifying the selected participant that the conference is starting, the conference thread 308 updates the status data 515 for the selected participant to indicate that the selected participant has been notified that the conference is starting (914). The conference thread 308 then determines again whether there are any remaining waiting participants (902) and the participant joining process 900 recurs.

After the conference thread 308 determines that there are no remaining waiting participants (“NO” of 902), the conference thread 308 continues performing the operation 700 illustrated in the example of FIG. 7.

FIG. 10 is a block diagram illustrating an example computing device 1000. In some embodiments, the communication devices 104 and the conferencing system 106 are implemented as one or more computing devices like the computing device 1000. It should be appreciated that in other embodiments, the communication devices 104 and the conferencing system 106 are implemented using computing devices having hardware components other than those illustrated in the example of FIG. 10.

As used herein, the term computer readable media may include computer storage media and communication media. As used in this document, a computer storage medium is a device or article of manufacture that stores data and/or computer-executable instructions. A computer storage medium does not consist of transitory signals. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

Communication media may include any information delivery media that carries computer readable instructions, data structures, program modules, or other data in a modulated data signal. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 10, the computing device 1000 comprises a memory 1002, a processing system 1004, a secondary storage device 1006, a network interface card 1008, a video interface 1010, a display unit 1012, an external component interface 1014, and a communication medium 1016. The memory 1002 includes one or more computer storage media capable of storing data 1018 and/or computer-executable instructions 1020.

The secondary storage device 1006 includes one or more computer storage media. The secondary storage device 1006 stores data 1022 and computer-executable instructions 1024 not directly accessible by the processing system 1004. In other words, the processing system 1004 performs an I/O operation to retrieve data and/or software instructions from the secondary storage device 1006.

The processing system 1004 includes one or more processing units. A processing unit is a physical device or article of manufacture comprising one or more integrated circuits that read data and instructions from computer readable media, such as the memory 1002 and the secondary storage device 1006, and selectively execute the instructions. In various embodiments, the processing system 1004 is implemented in various ways. For example, the processing system 1004 can be implemented as one or more processing cores. In another example, the processing system 1004 can comprise one or more separate microprocessors. In yet another example embodiment, the processing system 1004 can comprise an application-specific integrated circuit (ASIC) that provides specific functionality. In yet another example, the processing system 1004 provides specific functionality by using an ASIC and by executing computer-executable instructions.

The network interface card 1008 is a device or article of manufacture that enables the computing device 1000 to send data to and receive data from a communication network. In different embodiments, the network interface card 1008 is implemented in different ways. For example, the network interface card 1008 can be implemented as an Ethernet interface, a token-ring network interface, a fiber optic network interface, a wireless network interface (e.g., Wi-Fi, WiMax, etc.), or another type of network interface.

The video interface 1010 enables the computing device 1000 to output video information to the display unit 1012. The display unit 1012 can be various types of devices for displaying video information, such as a cathode-ray tube display, an LCD display panel, a plasma screen display panel, a touch-sensitive display panel, an LED screen, or a projector. The video interface 1010 can communicate with the display unit 1012 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1014 enables the computing device 1000 to communicate with external devices. For example, the external component interface 1014 can be a USB interface, a FireWire interface, a serial port interface, a parallel port interface, a PS/2 interface, and/or another type of interface that enables the computing device 1000 to communicate with external devices. In various embodiments, the external component interface 1014 enables the computing device 1000 to communicate with various external components, such as external storage devices, input devices, speakers, modems, media player docks, other computing devices, scanners, digital cameras, and fingerprint readers.

The communications medium 1016 facilitates communication among the hardware components of the computing device 1000. In the example of FIG. 10, the communications medium 1016 facilitates communication among the memory 1002, the processing system 1004, the secondary storage device 1006, the network interface card 1008, the video interface 1010, and the external component interface 1014. The communications medium 1016 can be implemented in various ways. For example, the communications medium 1016 can comprise a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1002 stores various types of data and/or software instructions. For instance, in the example of FIG. 10, the instructions 1020 in the memory 1002 can include Basic Input/Output System (BIOS) instructions 1026 and operating system instructions 1028. Execution of the BIOS instructions 1026 by the processing system 1004 causes the computing device 1000 to boot up. Execution of the operating system instructions 1028 causes the computing device 1000 to provide an operating system that coordinates the activities and sharing of resources of the computing device 1000. Furthermore, the memory 1002 stores application software 1030. Execution of the application software 1030 by the processing system 1004 configures the computing device 1000 to provide one or more applications. The memory 1002 also stores data 1018. The data 1018 is data used by programs that execute on the computing device 1000.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a first host join request at a conferencing system, the first host join request indicating that a host of a conference wants to join the conference, a first participant of the conference not having an active communication session with the conferencing system when the conferencing system receives the first host join request; and
in response to receiving the first host join request, notifying, by the conferencing system, the first participant that the conference is starting.

2. The method of claim 1, wherein notifying the first participant comprises making a telephone call to the first participant.

3. The method of claim 2, further comprising: joining the telephone call to the conference when the first participant answers the telephone call.

4. The method of claim 1, further comprising: receiving scheduling input at the conferencing system before receiving the first host join request, the scheduling input indicating a time at which the conference is scheduled to occur.

5. The method of claim 4, wherein the conferencing system receives the first host join request after the time at which the conference is scheduled to occur.

6. The method of claim 4,
wherein the scheduling input indicates a recurrence schedule for the conference, the recurrence schedule for the conference indicating a periodic basis on which the conference recurs; and
wherein the method further comprises:
receiving a second host join request at the conferencing system, the second host join request indicating that the host wants to join a recurrence of the conference, the first participant not having an active communication session with the conferencing system when the conferencing system receives the second host join request; and
in response to receiving the second host join request, notifying the first participant that that recurrence of the conference is starting.

7. The method of claim 1, further comprising: receiving, by the conferencing system, a notification request for the first participant before receiving the first host join request, the conferencing system notifying the first participant that the conference is starting because the conferencing system has received the notification request for the first participant.

8. The method of claim 7, further comprising:
receiving a first participant join request at the conferencing system, the conferencing system receiving the first participant join request from a first communication device, the first communication device associated with the first participant, the conferencing system receiving the first participant join request before receiving the first host join request; and
after receiving the first participant join request, notifying the first participant that the conference has not yet started.

9. The method of claim 8, further comprising:
establishing an initial communication session between the first communication device and the conferencing system, the conferencing system receiving the first participant join request during the initial communication session, the conferencing system receiving the notification request for the first participant during the initial communication session; and
terminating the initial communication session before the conferencing system receives the first host join request.

10. The method of claim 9,
wherein establishing the initial communication session comprises receiving a telephone call from the first communication device; and
wherein notifying the first participant that the conference has not yet started comprises sending voice data to the first communication device, the voice data representing a vocal message indicating that the conference has not yet started; and
wherein receiving the first participant join request comprises receiving a sequence of touch-tones representing a participant passcode for the conference.

11. The method of claim 8, further comprising: receiving a second participant join request at the conferencing system, the conferencing system receiving the second participant join request from a second communication device, the second communication device associated with a second participant of the conference, the conferencing system receiving the second participant join request prior to receiving the first host join request, the second participant not having an active communication session with the conferencing system when the conferencing system receives the first host join request,
wherein the conferencing system does not receive a notification request for the second participant before receiving the first host join request and the conferencing system does not notify the second participant that the conference is starting because the conferencing system did not receive a notification request for the second participant before receiving the first host join request.

12. The method of claim 1, further comprising:
establishing a second communication session, the second communication session being between the conferencing system and a second communication device, the second communication device associated with a second participant of the conference;
receiving a second participant join request at the conferencing system, the conferencing system receiving the second participant join request from the second communication device during the second communication session, the conferencing system receiving the second participant join request prior to receiving the first host join request, the conferencing system receiving the first host join request before the second communication session terminates; and
joining the second communication session to the conference.

13. A conferencing system comprising:
one or more computer storage media that store computer-executable instructions; and
a processing unit that reads the computer-executable instructions from the one or more computer storage media and executes the computer-executable instructions, execution of the computer-executable instructions by the processing unit configuring the conferencing system to:
receive a notification request from a first participant of a conference that was previously scheduled;
receive a host join request after receiving the notification request, the host join request indicating that a host of the conference wants to join the conference, the first participant not having a communication session with the conferencing system at a time that the conferencing system receives the host join request; and
in response to receiving the host join request, notifying the first participant that the conference is starting.

14. The conferencing system of claim 13, wherein receiving the notification request comprises receiving notification preference data from the first participant, the notification preference data indicating a manner in which the first participant wants to be notified that the conference is starting; and
wherein notifying the first participant that the conference is starting comprises notifying the first participant that the conference is starting in the manner in which the first participant wants to be notified that the conference is starting.

15. The conferencing system of claim 14, wherein notifying the first participant comprises sending a text message or an instant message to the first participant.

16. The conferencing system of claim 13, wherein the notification request comprises a series of touch-tones received from a telephone associated with the first participant.

17. The conferencing system of claim 13, wherein execution of the computer-executable instructions by the processing unit configures the conferencing system to:
establish a first communication session, the first communication session being between a first communication device and the conferencing system, the first communication device associated with the host;
establish a second communication session after the conferencing system receives the host join request, the second communication session being between a second communication device and the conferencing system, the second communication device associated with the first participant;
using the first communication session to send media data of the conference to the first communication device;
using the second communication session to send the media data of the conference to the second communication device.

18. The conferencing system of claim 17, wherein the media data of the conference includes one or more of: voice data, videoconferencing data, instant messaging data, and online meeting data.

19. The conferencing system of claim 13, wherein the conferencing system receives the notification request through a web services interface.

20. A computer storage medium that stores computer-executable instructions, execution of the computer-executable instructions by a processing unit of a conferencing system configuring the conferencing system to:
receive scheduling input for a conference, the scheduling input indicating a time at which the conference is scheduled to occur, the scheduling input indicating a first participant of the conference and a second participant of the conference;
receive a first telephone call from a first communication device at approximately the time at which the conference is scheduled to occur, the first communication device associated with the first participant;
receive a first participant join request from the first communication device during the first telephone call, the first participant join request indicating that the first participant wants to join the conference;
determine, in response to receiving the first participant join request, that a host of the conference has not yet joined the conference;
place the first telephone call on hold in response to determining that the host has not yet joined the conference;
receive a notification request from the first participant during the first telephone call while the first telephone call is on hold;
terminating the first telephone call after receiving the notification request;
receive a host join request after terminating the first telephone call, the conferencing system receiving the host join request after the time at which the conference is scheduled to occur, the host join request indicating that the host of the conference wants to join the conference;
in response to receiving the host join request, determining that the conferencing system has received the notification request from the first participant but has not received a notification request from the second participant;
in response to determining that the conferencing system has received the notification request from the first participant but not the second participant, making a second telephone call to the first participant and not making a telephone call to the second participant;
sending voice data of the conference to the first communication device through the second telephone call, the voice data of the conference representing sounds received from a communication device associated with the host and communication devices associated with other participants of the conference.
